(19) United States
(12) Patent Application Publication
(10) Pub. No.: US 2025/0200702 A1
(43) Pub. Date: Jun. 19, 2025

(54) SYSTEM FOR GRID-BASED IMAGE STORAGE AND DYNAMIC RECONSTRUCTION VIA SELECTIVE DEDUPLICATION OF COMMON IMAGE SEGMENTS

(71) Applicants: Nishanth Vepachedu, Holladay, UT (US); Srujan Reddy Anugu, Mason, OH (US); Durga Rao Manchikanti, South Jordan, UT (US); Hanumantha Rao Kavuri, Herriman, UT (US)

(72) Inventors: Nishanth Vepachedu, Holladay, UT (US); Srujan Reddy Anugu, Mason, OH (US); Durga Rao Manchikanti, South Jordan, UT (US); Hanumantha Rao Kavuri, Herriman, UT (US)

(21) Appl. No.: 19/070,563

(22) Filed: Mar. 5, 2025

(51) Int. Cl. G06T 3/4038; G06F 16/174; G06T 7/11

(52) U.S. Cl. CPC G06T 3/4038; G06F 16/1748; G06T 7/11

(57) ABSTRACT

The present invention introduces an innovative approach to cloud-based image storage that leverages grid-based segmentation and selective hashing to efficiently reduce storage space. By identifying and interning common image segments—while preserving unique elements such as faces—the system achieves a balance between storage efficiency and computational overhead. This method not only minimizes redundancy but also optimizes resource utilization, making it a compelling solution for large-scale cloud storage providers. The invention represents a significant advancement over traditional deduplication techniques, offering improved storage management in environments where repeated image content is prevalent.

### TECHNICAL FIELD

The present invention relates to cloud-based image storage and retrieval systems, particularly those that optimize storage efficiency through deduplication of common image segments.

### BACKGROUND OF THE INVENTION

With the rapid growth of digital photography and social media, cloud storage systems face significant challenges in handling vast amounts of image data. Many images contain identical or highly similar background elements, leading to redundant storage of identical visual information. Current deduplication techniques operate at a whole-file level, which does not effectively address the issue of repetitive visual elements within images. Thus, a more granular approach is needed to optimize storage efficiency while maintaining high-fidelity image retrieval.

Thus, there is a need for a system for grid-based image storage and dynamic reconstruction via selective deduplication of common image segments.

### BRIEF SUMMARY OF THE INVENTION

The present invention provides a cloud-based image storage system that reduces storage requirements by decomposing each stored image into a fixed grid (e.g., 9×9 segments). Each segment is analyzed, and a hash is generated for segments that do not contain prominent facial features. If a segment's hash matches a pre-existing hash in a shared common pool (e.g., a well-known landmark appearing in multiple images), the corresponding segment data is not redundantly stored. Instead, the system maintains a reference to the common image portion. Upon retrieval, the system dynamically reconstructs the final image by combining the user's unique segments with the shared segments from the common pool. This technique significantly reduces storage space while introducing a manageable computational cost during image reconstruction.

### BRIEF DESCRIPTION OF THE DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 illustrates system architecture according to one embodiment of the invention.

FIG. 2 illustrates internal component Diagram for Image Ingestion Module according to one embodiment of the invention.

FIG. 3 illustrates internal flow diagram for Image Ingestion Module according to one embodiment of the invention.

FIG. 4 illustrates segmentation and hash generation engine Module according to one embodiment of the invention.

FIG. 5 illustrates shared segmentation repository according to one embodiment of the invention.

FIG. 6 illustrates dynamic assembly module according to one embodiment of the invention.

The drawings described herein are for illustration purposes only and are not intended to limit the scope of the present invention in any way.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. In addition, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

According to one embodiment of the invention, a system for efficient cloud-based image storage and retrieval is disclosed. The system includes an image processing module configured to decompose an image into a grid of uniform segments; a feature analysis module that identifies and isolates segments containing prominent facial features; a hashing module that generates a unique hash for each non-facial segment; a storage module that compares the segment hash to a shared common pool of pre-existing segment hashes; a deduplication module that prevents redundant storage of segments matching an existing hash by maintaining a reference to the common image segment; and a reconstruction module configured to dynamically reassemble the image upon retrieval by combining unique user-stored segments with referenced common segments.

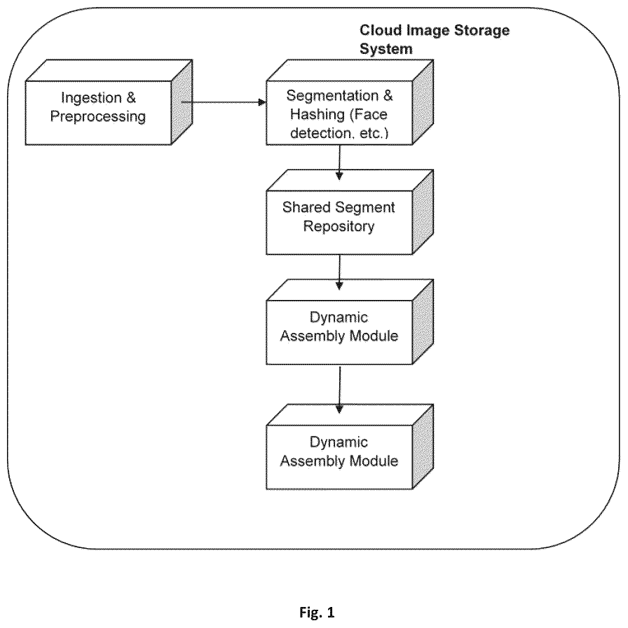

FIG. 1 illustrates system architecture according to one embodiment of the invention. As shown in FIG. 1, the system architecture includes ingestion and preprocessing module, segmentation and hashing module, shared segment repository module, dynamic assembly module.

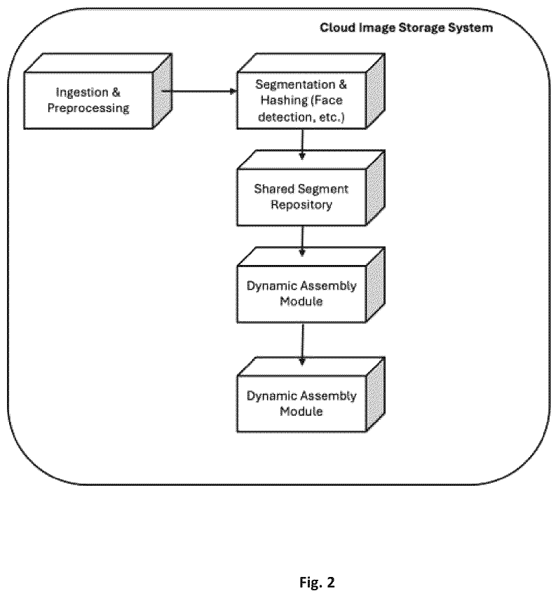

FIG. 2 illustrates internal component Diagram for Image Ingestion Module according to one embodiment of the invention. As shown in FIG. 2, the overall system is composed of four major modules. Each module is designed with its internal flow and subcomponents to ensure efficient processing and storage optimization. The following sections describe each module in detail, along with a corresponding internal flow diagram.

Image Ingestion Module: This module is responsible for receiving user-uploaded images and preparing them for further processing. Its primary functions include:
a) image reception: securely accepting image files from various input sources (web upload, mobile app, API, etc.).
b) preprocessing module: performing initial operations such as format validation, normalization (e.g., scaling, color correction), and metadata extraction.
c) queueing for Segmentation: Placing images into a processing queue to be sent to the Segmentation and Hash Generation Engine.

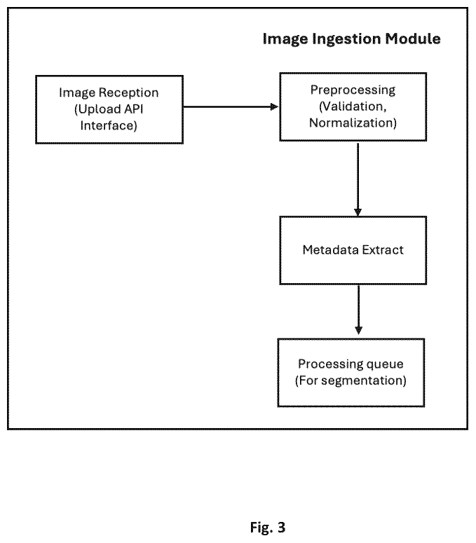

FIG. 3 illustrates internal flow diagram for Image Ingestion Module according to one embodiment of the invention. This module is responsible for receiving user-uploaded images and preparing them for further processing.

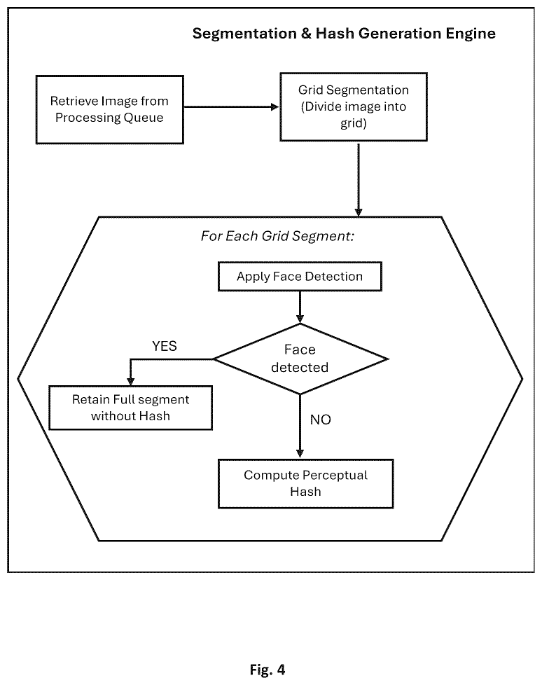

FIG. 4 illustrates segmentation and hash generation engine Module according to one embodiment of the invention. As shown in FIG. 4, this engine takes each preprocessed image and divides it into a fixed grid (e.g., 9×9). Its internal operations include:
a) grid Segmentation: dividing the image into equal segments;
b) face Detection and Filtering: Analyzing each segment using face detection algorithms (such as Haar cascades or CNN-based detectors) to determine if the segment contains prominent facial features

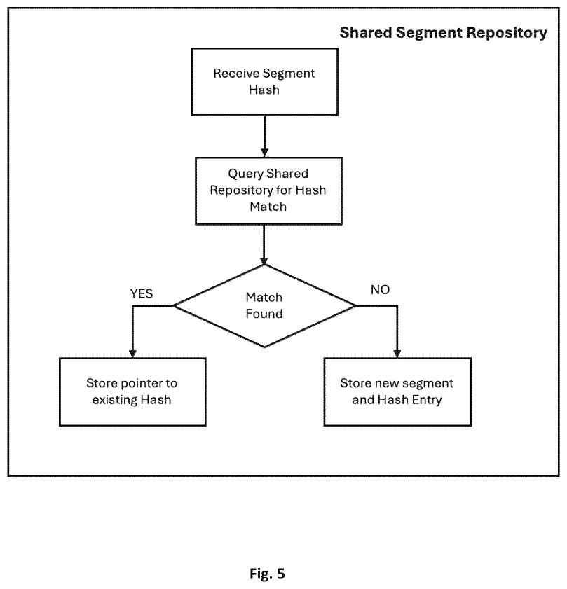

FIG. 5 illustrates shared segmentation repository according to one embodiment of the invention.

As shown in FIG. 5, this repository stores common image segments and their corresponding hash values. The key functions include:
a) Hash Lookup: Comparing newly generated hashes with existing ones in the repository;
b) Storage Decision: if a matching hash is found, the module records a pointer to the shared segment rather than storing a duplicate, and if no match is found, the segment data along with its hash is stored as a new entry;
c) Maintenance Operations: Managing versioning and reference counts to ensure data integrity and handling updates or deletions without affecting image reconstruction.

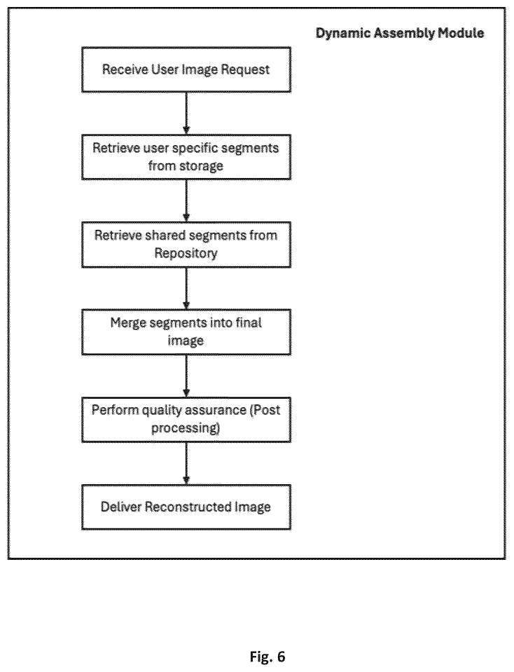

FIG. 6 illustrates dynamic assembly module according to one embodiment of the invention. As shown in FIG. 6, this module is responsible for reconstructing the final image when a user requests it. Its core functions are:
a) Segment Retrieval: Fetching user-specific segments from dedicated storage and shared segments from the repository;
b) Image Merging: Dynamically merging the segments in their proper grid positions to reconstruct the complete image;
c) Quality Assurance: Applying any necessary post-processing to ensure that the merged image maintains visual fidelity with the original.

Advantages of the present invention: The following are the advantages of the present invention:
i) Storage Efficiency: Reduces redundant storage of common image elements.
ii) Privacy Preservation: Ensures unique storage of facial features.
iii) Scalability: Adaptable to large-scale cloud storage systems.
iv) Cost Savings: Minimizes cloud storage expenses for service providers and users.
v) Dynamic Reconstruction: Provides high-fidelity image retrieval despite deduplication.

The present invention introduces an innovative approach to cloud-based image storage that leverages grid-based segmentation and selective hashing to efficiently reduce storage space. By identifying and interning common image segments—while preserving unique elements such as faces—the system achieves a delicate balance between storage efficiency and computational overhead. The dynamic image reconstruction process ensures that the end-user receives a complete and visually accurate image despite the segmented storage approach. This method not only minimizes redundancy but also optimizes resource utilization, making it a compelling solution for large-scale cloud storage providers. The invention represents a significant advancement over traditional deduplication techniques, offering improved storage management in environments where repeated image content is prevalent.

It will be recognized that the above described subject matter may be embodied in other specific forms without departing from the scope or essential characteristics of the disclosure. Thus, it is understood that, the subject matter is not to be limited by the foregoing illustrative details, but it is rather to be defined by the appended claims.

While specific embodiments of the invention have been shown and described in detail to illustrate the novel and inventive features of the invention, it is understood that the invention may be embodied otherwise without departing from such principles.

What is claimed is:

1. A system for efficient cloud-based image storage and retrieval, the system comprising:
a) an image processing module configured to decompose an image into a grid of uniform segments;
b) a feature analysis module that identifies and isolates segments containing prominent facial features;
c) a hashing module that generates a unique hash for each non-facial segment;
d) a storage module that compares the segment hash to a shared common pool of pre-existing segment hashes;
e) a deduplication module that prevents redundant storage of segments matching an existing hash by maintaining a reference to the common image segment; and
f) a reconstruction module configured to dynamically reassemble the image upon retrieval by combining unique user-stored segments with referenced common segments.

2. The system as claimed in claim 1, wherein the hashing module utilizes perceptual hashing techniques to account for minor variations in segment appearance.

3. The system as claimed in claim 1, wherein the feature analysis module uses deep learning-based facial recognition algorithms to identify and exclude facial segments from deduplication.

4. The system as claimed in claim 1, wherein the shared common pool is periodically updated to optimize storage efficiency and accommodate new commonly occurring segments.

5. The system as claimed in claim 1, wherein the grid decomposition size is dynamically adjustable based on image resolution and complexity.

6. The system of claim 1, wherein the reconstruction module performs on-demand synthesis of missing segments in cases where common references are no longer available.

7. The system as claimed in claim 1, wherein the system supports encryption of image segments to ensure security and privacy of stored and referenced data.

8. The system as claimed in claim 1, wherein user preferences allow customization of storage efficiency versus reconstruction speed trade-offs.
